(19) United States
(12) Patent Application Publication
(10) Pub. No.: US 2016/0185360 A1
(43) Pub. Date: Jun. 30, 2016

(54) Head End Power Module Control System

(71) Applicant: Electro-Motive Diesel, Inc., Lagrange, IL (US)

(72) Inventor: Madan Mohan Jalla, Woodridge, IL (US)

(73) Assignee: Electro-Motive Diesel, Inc., Lagrange, IL (US)

(21) Appl. No.: 14/586,342

(22) Filed: Dec. 30, 2014

(51) Int. Cl. B61C 17/00; H02M 7/44

(52) U.S. Cl. CPC B61C 17/00; H02M 7/44

(57) ABSTRACT

The present disclosure is directed to a method for controlling a power module for a locomotive. The method may include inverting a common power at a first location and outputting a first inverted power. The method may also include inverting the common power at a second location and outputting a second inverted power. The method may further include retrieving a power characteristic indicative of the first inverted power, and selectively adjusting the second inverted power to match the first inverted power based on the retrieved power characteristic.

### TECHNICAL FIELD

The present disclosure relates generally to a control system and, more particularly, to a control system for a head end power module.

### BACKGROUND

Passenger train locomotives include a head end power module for generating power for auxiliary demands on the train such as lighting, a 120 V power supply, and other electric needs. The head end power module, usually at the front of the locomotive or “head” of the train, is often equipped with at least one internal combustion engine to drive one or more electric generators. Some head end power modules include one or more power inverters to invert varying input DC link voltage from the generator to a constant output AC voltage. In order to produce constant power to supply the auxiliary demands, the generator typically runs at a high RPM (usually top operational speed) at all times. When the train is stopped at a station, running the generator at top speed may be loud and may consume high amounts of fuel.

One example of a system for converting AC power is described in U.S. Pat. No. 7,385,372 (“the '372 patent”) filed by Ahmad on Jun. 10, 2008. The '372 patent describes a system that includes two inverters arranged in parallel to receive DC power from two rectifiers. The two inverters provide power to one or more traction motors and to auxiliary devices. By using two inverters, the generator may be run at low speeds.

Although the '372 patent may provide for reduced generator speeds, it may still be less than optimal. In particular, the system of the '372 patent may be difficult to control. In order to reduce the operational speed of the generator, the two power inverters must be configured in parallel. However, synchronization of the two power inverters may be sub-optimal at lower speeds because control of two inverters configured in parallel is difficult. In particular, the output of the two converters is difficult to synchronize when controlled together due to varying generator speeds in operation. Without synchronized independent control of the power inverters, an associated harmonic content may be unnecessarily high.

The head end power module control system of the present disclosure solves one or more of the problems set forth above and/or other problems in the art.

### SUMMARY

In one aspect, the present disclosure is directed to a control system for a power module for a locomotive comprising a first power inverter, a second power inverter, a first controller connected to the first power inverter, and a second controller connected to the second power inverter. The second controller may be configured to selectively shift an operational phase of the second power inverter. The control system may also include a master controller connected to the first controller and the second controller.

In another aspect, the present disclosure is directed to a method for controlling a power module for a locomotive. The method may include inverting a common power at a first location and outputting a first inverted power. The method may also include inverting the common power at a second location and outputting a second inverted power. The method may further include retrieving a power characteristic indicative of the first inverted power, and selectively adjusting the second inverted power to match the first inverted power based on the retrieved power characteristic.

In another aspect, the present disclosure is directed to a control system for a locomotive. The control system may include a first power inverter, a second power inverter connected in parallel with the first power inverter, and a first controller operatively connected to the first power inverter and configured to control the first power inverter. The control system may also include a second controller operatively connected to the second power inverter and configured to control the second power inverter. The second controller may be configured to retrieve a power characteristic from the first controller, where the power characteristic is indicative of power from the first power inverter. The second controller may control an output of the second power inverter to match the output of the first power inverter based on the retrieved power characteristic, and selectively shift an operational phase of the output of the second power inverter by about 180 degrees. The second controller may transmit a signal indicative of operational readiness when the output of the second power inverter is shifted. A master controller may be connected to the first controller and the second controller, and may include a locomotive controller. The locomotive controller may be configured to receive the signal indicative of operational readiness and connect a trainline load to the outputs of the first and second power inverters based on the signal indicative of operational readiness.

### BRIEF DESCRIPTION OF THE DRAWINGS

FIG. 1 is a diagrammatic illustration of an exemplary disclosed locomotive;

FIG. 2 is a diagrammatic illustration of an exemplary disclosed head end power module that may be used in conjunction with the locomotive of FIG. 1;

FIG. 3. is a diagrammatic illustration of an exemplary disclosed control system that may be used in conjunction with the head end power module of FIG. 2;

FIG. 4 is a flow chart showing an exemplary operation of the control system of FIG. 3.

### DETAILED DESCRIPTION

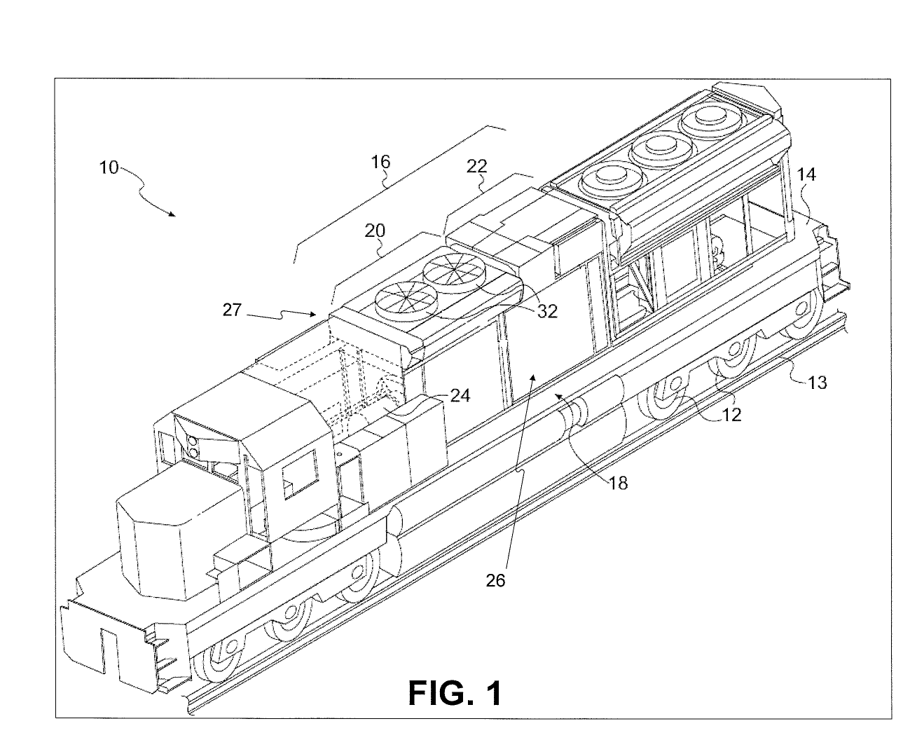

FIG. 1 illustrates a locomotive 10 having a plurality of wheels 12 configured to engage a track 13, a base platform 14 supported by wheels 12, and one or more head end power modules 16 (“power modules”) mounted to base platform 14 and configured to drive wheels 12. Any number of power modules 16 may be included within locomotive 10 and operated to produce power that may be transferred to traction motors (not shown) used to drive wheels 12, and to provide auxiliary power service for passenger cars (not shown) towed by locomotive 10. In the exemplary embodiment shown in FIG. 1, locomotive 10 includes a single head end power module 16 aligned on base platform 14 along a length or travel direction of locomotive 10.

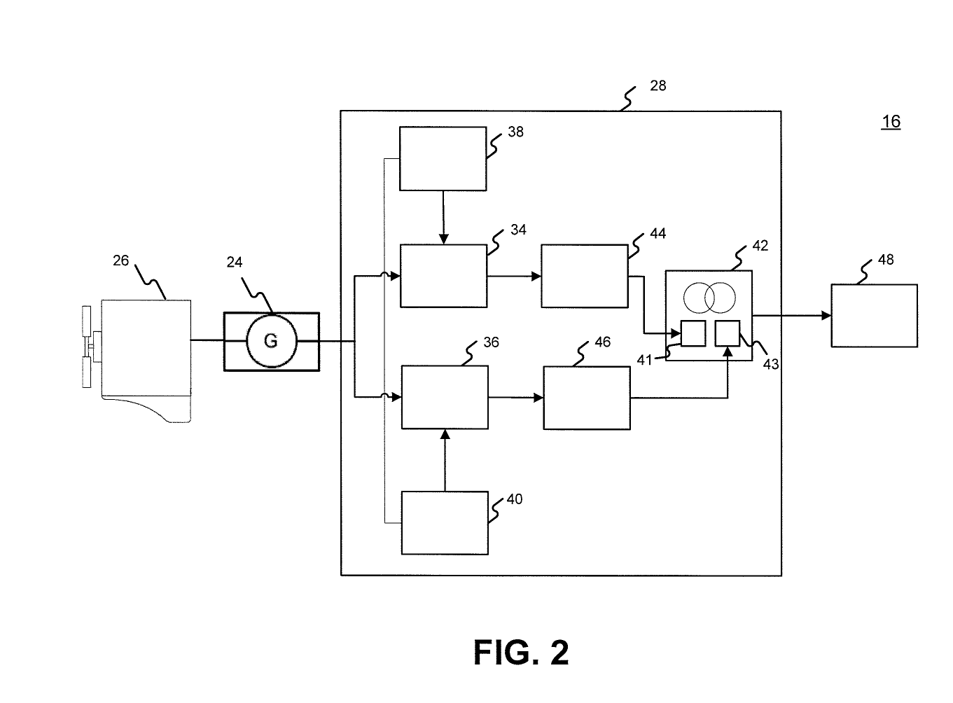

Head end power module 16 may be at least partially covered by an enclosure 18 and divided into a generator section 20 and an engine section 22 located rearward of generator section 20. Generator section 20 may house a generator 24 that is driven by a power source 26 (shown only in FIG. 2), which may be housed within engine section 22.

Power source 26 may be an internal combustion engine such as a diesel engine, a gasoline engine, or a gaseous-fuel powered engine that combusts a mixture of fuel and air to generate a mechanical input to generator 24. It is contemplated that head end power module 16 may be used with another type of power source such as, for example, a fuel cell.

Generator 24 may be connected to power source 26. Generator 24 may be a three-phase permanent magnet alternating field-type generator, an AC synchronous generator, or a switched-reluctance generator that is mechanically driven by power source 26 to produce electrical power. Generator 24 may be configured to produce a power output in response to a rotational input from power source 26. It is also contemplated that generator 24 may be a switched reluctance generator, a synchronous alternator, or any other appropriate type of generator known in the art. Generator 24 may include a rotor (not shown) rotatably connected to power source 26 by any means known in the art such as, for example, by a direct crankshaft connection, via a gear train, through a hydraulic circuit, or in any other appropriate manner. Generator 24 may be configured to produce electrical power output as the rotor is rotated within a stator (not shown) by power source 26.

A dynamic brake 27 may be associated with power module 16 and may include a resistive grid/fan combination connected to the motors (not shown) that drive wheels 12. During a dynamic braking event, the motors can be operated as generators, using wheels 12 to apply torque and generate electricity. The torque applied by the wheels 12 may slow locomotive 10, while the electricity may be directed through a resistive grid of dynamic brake 27. One or more fans 32 may be used to blow air through the grid to cool the grid and exhaust heated air out of locomotive 10.

FIG. 2 depicts an exemplary disclosed head end power module 16 that may be used in conjunction with locomotive 10 of FIG. 1. As illustrated in FIG. 2, power source 26 may connect to generator 24 to supply power to an inverter module 28. Inverter module 28 may receive power from generator 24, rectify the power to DC, and provide the DC power to a head end power (HEP) trainline 48.

Inverter module 28 may include a first head end power inverter 34 (hereafter “inverter 34”) and a second head end power inverter 36 (hereafter “inverter 36”). Inverters 34 and 36 may be connected to and independently controlled by a respective one of a first controller 38 and a second controller 40. Inverters 34 and 36 may be connected in parallel, and each may connect to an independent winding of a transformer 42 through separate line filters 44 and 46. For example, inverter 34 may connect to transformer 42 through a first primary winding 41, and inverter 36 may connect to transformer 42 through a second primary winding 43. Transformer 42 may supply power to head end power trainline 48.

Inverters 34 and 36 may receive DC power from one or more power sources, such as, for example, a third rail system (not shown), a battery (not shown), a hydrogen powered fuel cell (not shown), a supercapicitor (not shown), a braking system (e.g., dynamic brake 27) and/or one or more generators (e.g., generator 24). Power inverters 34 and 36 may rectify the power to three-phase 480 Vac output. The three-phase output may be provided to HEP trainline 48. Inverters 34 and 36 may each be uni-directional or bi-directional traction inverters. Power inverters 34 and 36 may each include one or more solid state devices including one or more diodes (not shown), one or more insulated gate bipolar transistors (IGBTs) (not shown), and/or one or more DC bus capacitors (not shown).

Controllers 38 and 40 may be in communication with inverters 34 and 36, respectively. Controllers 38 and 40 may also directly connect to each other, and may send information, receive information, and/or retrieve information, such as, for example, one or more power characteristic associated with the inverter to which each controller is connected. Each of controllers 38 and 40 may be configured to independently control the inverter to which it is connected. Controllers 38 and 40 may be embodied in a single microprocessor or multiple microprocessors and could be integrated into a respective one of inverters 34 and 36. Numerous commercially available microprocessors can be adapted to perform the functions of controllers 38 and 40. For example, controllers 38 and 40 may be field-programmable gate arrays (FPGAs). It should be appreciated that controllers 38 and 40 could readily be embodied in a general locomotive microprocessor capable of controlling numerous locomotive functions.

Controllers 38 and 40 may each include any means for storing and comparing information and controlling an operating parameter of locomotive 10 such as a memory, one or more data storage devices, or any other components that may be used to run an application. Furthermore, although aspects of the present disclosure may be generally described as being stored in memory, one skilled in the art will appreciate that these aspects can be stored on or read from types of computer-related products or computer-readable media such as computer chips and secondary storage devices, including hard disks, floppy disks, optical media, CD-ROM, or other forms of RAM or ROM. Various other known circuits may be associated with controllers 38 and 40, including power supply circuitry, signal-conditioning circuitry, solenoid driver circuitry, communication circuitry, and other appropriate circuitry.

Line filters 44 and 46 may receive AC power from inverters 34 and 36, respectively. Line filters 44 and 46 may be inductor-capacitor (LC) type filters configured to filter each of the three phases of power output for each of inverters 34 and 36. The purpose of line filters 44 and 46 may be to reduce the total harmonic distortion of the AC voltage on the output of inverters 34 and 36. The total harmonic distortion, or THD, of a signal is a measurement of the harmonic distortion present and is defined as a ratio of a sum of powers of all harmonic components to a power of a fundamental frequency. THD is used to characterize the power quality of electric power systems. Line filter 44 may receive AC power from inverter 34, remove harmonic content from the three-phase AC signal, and connect to first primary winding 41 of transformer 42. Line filter 46 may receive AC power from inverter 36, remove harmonic content from the three-phase AC signal, and connect to second primary winding 43 of transformer 42.

Transformer 42 may be a two primary delta-delta-wye type three-phase transformer. The purpose of transformer 42 may be to provide isolation for HEP trainline 48 and to step the output of line filters 44 and 46 down to a steady and useful voltage. For example, transformer 42 may receive power output from line filters 44 and 46 and step the voltage to about 480 Vac.

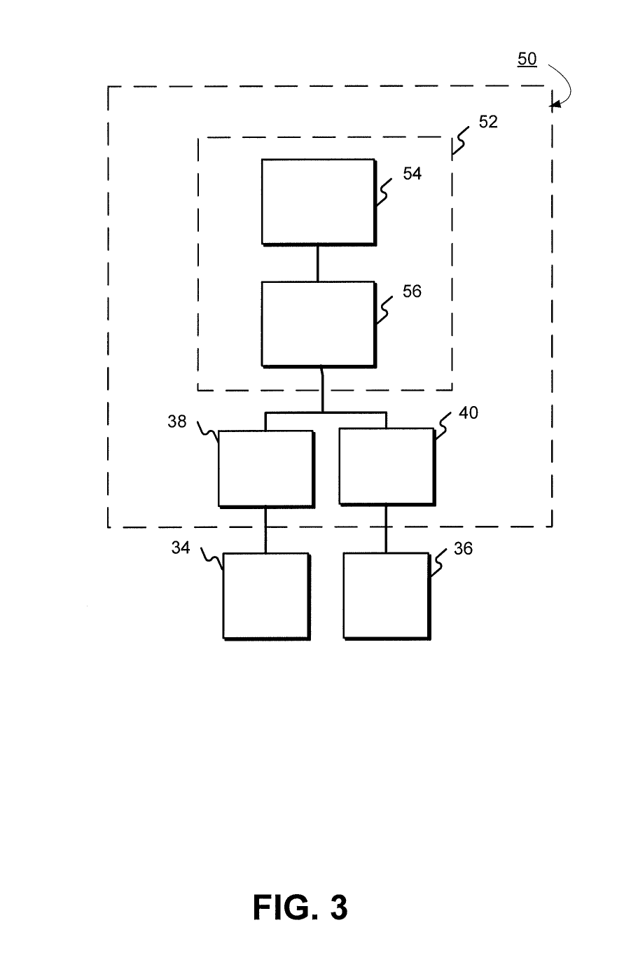

FIG. 3 depicts an exemplary embodiment of control a system 50 for use in controlling head end power module 16. Control system 50 may include a master controller 52, which may be in communication with controllers 38 and 40. As described above, controller 38 may be in communication with inverter 34, and may be configured to independently control inverter 34. Controller 40 may be in communication with inverter 36, and may be configured to independently control inverter 36. Controllers 38 and 40 may also be in communication with each other and may be configured to retrieve one or more power characteristics from the other controller. For example, controller 40 may be configured to retrieve, from controller 38, a voltage, a current, an operational phase of the output power, etc. Controllers 38 and 40 may also be configured to receive a request from another controller to provide one or more power characteristics.

Master controller 52 may include an input/output interface 54 (“interface 54”) and a locomotive controller 56. Locomotive controller 56 may be configured to control operational aspects of locomotive 10, such as, for example, braking, traction control, etc. Master controller 52 may be in communication with one or more sensors (not shown) sensing various aspects of head end power module 16. For example, master controller 52 may be configured to determine power characteristics of the common DC input, input and output of line filters 44 and 46, and/or input and output of transformer 42. Master controller 52 may be configured to monitor power characteristics of the power inverted by inverters 34 and 36. For example, master controller 52 may monitor controllers 38 and 40 and retrieve information indicative of output voltage, operational phase (e.g., the fundamental frequency of the inverted power), current, etc. Master controller 52 may be configured to monitor controllers 38 and 40 for power control faults such as, for example, over current on the common DC input, over current on the output of inverters 34 and 36, ground fault, hardware over/under voltage, transformer output, etc.

Master controller 52 may include any means for monitoring, recording, storing, indexing, processing, and/or communicating various operational aspects of locomotive 10. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Master controller 52 may be configured to execute instructions stored on computer readable medium to perform methods of remote control of locomotive 10. For example, master controller 52 may control operations of one or more traction motors (not shown), power source 26 and/or one or more engines (not shown) in engine section 22. Master controller 52 may include input/output interface 54 and may be operably connected to locomotive controller 56 and controllers 38 and 40. Master controller 52 may be configured to request information indicative of one or more power characteristics from controllers 38 and/or 40. Additionally and/or alternatively, master controller 52 may receive information indicative of one or more power characteristics from controllers 38 and/or 40, and/or receive one or more signals from controllers 38 and/or 40 indicating operational readiness for load connection (e.g., HEP trainline 48).

Interface 54 may include means to receive user input (e.g., a keyboard, touchscreen, etc.) and/or provide output indicative of operational aspects of locomotive 10 (e.g., a monitor, digital display, etc.), including operation of head end power module 16. For example, interface 54 may receive power characteristic information from one or more of controllers 38 and 40. Interface 54 may output an indication of the power characteristic

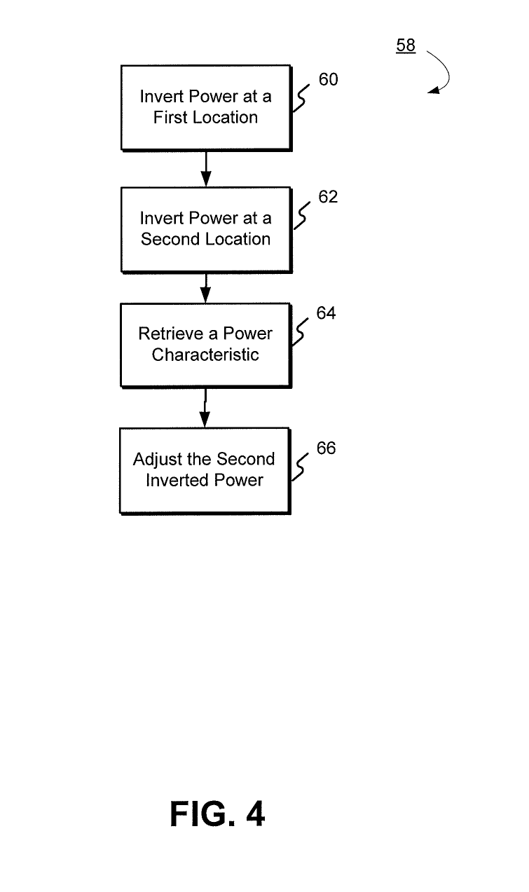

FIG. 4 will be discussed further in the following section to better illustrate the disclosed system and its operation.

### INDUSTRIAL APPLICABILITY

Although the disclosed power module may apply to different machines where generation of high quality (low harmonic distortion) AC power is needed, the disclosed power module may find particular applicability with mobile machines such as locomotives that typically operate at varying motor speeds. The disclosed power module may provide power with low harmonic distortion, while operating at lower overall engine RPMs.

According to one aspect illustrated in FIG. 4, the disclosed system may provide a method 58 performed by power control system 50 (“control system 50”) to control module 16. Method 58 may include receiving a common DC power from one or more DC power supplies (e.g., generator 24 and/or dynamic brake 27) at a first location, such as, for example, at inverter 34, and inverting the common DC power to a first inverted power (step 60). First inverted power may be AC power maintained at a particular voltage. The method may also include simultaneously receiving the common DC power from one or more DC power supplies at a second location, such as, for example, at inverter 36, and inverting the common DC power to a second inverted power (step 62). The second inverted power may also be AC power maintained at a particular voltage. The voltage of the second inverted power may be substantially the same voltage as the first inverted power. In another aspect, the second inverted power may have a voltage different than the first inverted power. The DC power received by inverters 34 and 36 from generator 24 may be considered “common power,” because inverter 34 and inverter 36 may be configured in parallel, and the common DC power may be inverted in parallel.

At step 64, control system 50 may retrieve a power characteristic. In particular, controller 40 may retrieve a power characteristic from controller 38. More particularly, controller 38 may determine one or more power characteristics of the first inverted power. A power characteristic may be, for example, voltage, current, temperature, total harmonic distortion (THD), and/or other characteristics associated with the first inverted power output by inverter 34. Controller 40, which may be connected to and controlling inverter 36, may monitor the power characteristic at the first location, and selectively adjust a voltage of the second inverted power based on the retrieved power characteristic.

Controller 40 may direct inverter 36 to adjust the second inverted power to match the voltage of the first inverted power based on the power characteristic (step 66). Inverter 36 may adjust, for example, voltage and/or current of the second inverted power. Controller 40 may be configured to continually monitor the power characteristic at the first location, and selectively adjust a voltage of the second inverted power based on the power characteristic so that the voltage of the second inverted power matches the voltage of the output first inverted power.

Systems with two power inverters connected in parallel may benefit from synchronizing the power at the second inverter to match the fundamental frequency of the first inverter, and shifting the operational phase of the second inverter (more particularly, shifting the phase of the second inverted power). In one aspect, the overall quality of power produced by head end power module 16 may be improved due to lower harmonic content. According to one aspect, at step 64, the operational phase of the second inverted power may be synchronized to the operational phase of the first inverted power and shifted by about 180 degrees from the operational phase of the first inverted power. By shifting the operational phase of the second inverted power, harmonic content (e.g., THD) may be reduced. As a result of shifting the operational phase of the second inverted power, the total harmonic distortion (THD) of the power connected to HEP trainline 48 may include less than 5% THD. After the second inverted power is shifted, the first and second inverted power are passed through line filters 44 and 46 and transformed into transformed power at transformer 42. The transformed power may be optimized and operationally ready for connection to the auxiliary power circuit (e.g., HEP trainline 48) as a result of the phase shift of the second inverted power and the effect of line filters 44 and 46. One or more of controllers 38 and/or 40 may transmit a signal to master controller 52 indicative of the operational readiness of power module 16 to supply power to HEP trainline 48.

It will be apparent to those skilled in the art that various modifications and variations can be made to the disclosed control system without departing from the scope of the disclosure. Other embodiments of the control system will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A control system for a power module for a locomotive, comprising:
a first power inverter;
a second power inverter;
a first controller connected to the first power inverter;
a second controller connected to the second power inverter and configured to selectively shift an operational phase of the second power inverter; and
a master controller connected to the first controller and the second controller.

2. The control system of claim 1, wherein the first power inverter is connected in parallel with the second power inverter.

3. The control system of claim 1, wherein the first controller is configured to independently control operation of the first power inverter.

4. The control system of claim 1, wherein the second controller is configured to independently control operation of the second power inverter.

5. The control system of claim 1, wherein the second controller is operatively connected to the first power inverter and is configured to determine a power characteristic from an output of the first power inverter.

6. The control system of claim 1, wherein the master controller includes a locomotive controller and a user interface in communication with the locomotive controller, the user interface being configured to output an indication of a power characteristic.

7. The control system of claim 5, wherein the second controller is operatively connected to the first power inverter via the first controller.

8. The control system of claim 1, wherein the second controller is configured to:
retrieve a power characteristic from the first controller;
control an output of the second power inverter to match an output of the first power inverter based on the retrieved power characteristic; and
transmit a signal to the master controller indicating operational readiness after retrieving the power characteristic.

9. The control system of claim 8, wherein prior to transmitting a signal to the master controller indicating operational readiness the second controller is further configured to selectively shift the operational phase of the output of the second power inverter based on the retrieved power characteristic.

10. The control system of claim 9, wherein the second operational phase is shifted by about 180 degrees from a first operational phase of the output of the first power inverter.

11. A method for controlling a power module for a locomotive, comprising:
inverting a common power at a first location and outputting a first inverted power;
inverting the common power at a second location and outputting a second inverted power;retrieving a power characteristic indicative of the first inverted power;
and selectively adjusting the second inverted power to match the first inverted power based on the retrieved power characteristic.

12. The method of claim 11, further including transmitting a signal to a master controller indicating operational readiness after selectively adjusting the second inverted power.

13. The method of claim 12, further including selectively connecting a trainline load to the master controller based on the signal.

14. The method of claim 11, wherein the common power at the first location and the common power at the second location are inverted in parallel.

15. The method of claim 11, wherein the retrieved power characteristic may be one or more of voltage, current, and operational phase.

16. The method of claim 11, wherein adjusting the second inverted power includes selectively adjusting an operational phase of the second inverted power.

17. The method of claim 16, wherein the operational phase of the second inverted power is shifted by about 180 degrees from an operational phase of the first inverted power.

18. The method of claim 11, wherein the first inverted power and the second inverted power include less than 5% total harmonic distortion (THD).

19. The method of claim 11, further including
monitoring the power characteristic at the first location; and
selectively adjusting a voltage of the second inverted power based on the monitored power characteristic so that the voltage of the second inverted power matches a voltage of the first inverted power.

20. A control system for a locomotive, comprising:
a first power inverter;
a second power inverter connected in parallel with the first power inverter;
a first controller operatively connected to the first power inverter and configured to control the first power inverter;
a second controller operatively connected to the second power inverter and configured to control the second power inverter, the second controller configured to:
retrieve a power characteristic from the first controller, wherein the power characteristic is indicative of power from the first power inverter;
control an output of the second power inverter to match the output of the first power inverter based on the retrieved power characteristic;
selectively shift an operational phase of the output of the second power inverter by about 180 degrees and;
transmit a signal indicative of operational readiness when the output of the second power inverter is shifted; and
a master controller connected to the first controller and the second controller, wherein the master controller includes a locomotive controller configured to receive the signal indicative of operational readiness and connect a trainline load to the outputs of the first and second power inverters based on the signal indicative of operational readiness.
